(19) United States
(12) Patent Application Publication
(10) Pub. No.: US 2013/0194394 A1
(43) Pub. Date: Aug. 1, 2013

(54) Energy Conserving Display

(71) Applicant: Peter Rae Shintani, San Diego, CA (US)

(72) Inventor: Peter Rae Shintani, San Diego, CA (US)

(21) Appl. No.: 13/363,627

(22) Filed: Feb. 1, 2012

(51) Int. Cl. G06F 3/038; H04N 13/04; G06T 15/00

(52) U.S. Cl. 348/51; 345/419; 348/E13.075

(57) ABSTRACT

A method of adjusting pixel height in a display panel having sub-pixelized pixels capable of operating in at least a tall mode and a short mode involves at a detector coupled to the display panel, detecting a position of a viewer viewing the display; at a processor, calculating a vertical viewing angle for a viewer; at the processor, determining if the calculated vertical viewing angle is within a predetermined range of vertical viewing angles; and the processor selecting a tall mode or a short mode for operation of the display panel as a result of the determining. This abstract is not to be considered limiting, since other embodiments may deviate from the features described in this abstract.

### COPYRIGHT AND TRADEMARK NOTICE

A portion of the disclosure of this patent document contains material which is subject to copyright protection. The copyright owner has no objection to the facsimile reproduction of the patent document or the patent disclosure, as it appears in the Patent and Trademark Office patent file or records, but otherwise reserves all copyright rights whatsoever. Trademarks are the property of their respective owners.

### BACKGROUND

In certain 3D display panels such as micropolarized display panels, there are techniques to widen the vertical viewing angle. Often the vertical viewing angle is primarily limited by cross-talk between left eye and right eye images. This is accomplished by having a display with pixels that are made up of sub-pixels, which can be selectively controlled.

The vertical height of each pixel is flexible. When a wide viewing angle is used, as for example when the display is used to play three dimensional content, the vertical height of each pixel is reduced. This is accomplished by not turning on a portion of the sub pixel. This reduces the possibility of cross-talk between left and right eye images. However, this requires that the back light be driven brighter to compensate for the smaller aperture ratio in an LCD display to achieve comparable brightness. This creates a tradeoff between wider viewing angle and power consumption.

### BRIEF DESCRIPTION OF THE DRAWINGS

Certain illustrative embodiments illustrating organization and method of operation, together with objects and advantages may be best understood by reference to the detailed description that follows taken in conjunction with the accompanying drawings in which:

FIG. 1 is an example of a micropolarized sub-pixilated display panel consistent with certain embodiments of the present invention.

FIG. 2 is an example of a flow chart of an operational process consistent with implementations of certain embodiments of the present invention.

FIG. 3 is an example of another process of operation of implementations consistent with certain embodiments of the present invention.

FIG. 4 is an example of a process of eye detection consistent with certain embodiments of the present invention.

FIG. 5 is an example of eye detection used to adjust a tilt angle of a display panel in a manner consistent with certain embodiments of the present invention.

FIG. 6 is an example of 3D glasses detection consistent with certain embodiments of the present invention.

FIG. 7 is an example of 3D glasses detection used to adjust a tilt angle of a display panel in a manner consistent with certain embodiments of the present invention.

FIG. 8 is an example of indirect measurement and deduction of eye location consistent with certain embodiments of the present invention.

FIG. 9 is an example of indirect measurement used to deduce the tilt angle correction of a display panel in a manner consistent with certain embodiments of the present invention.

FIG. 10 is an example of a television receiver device consistent with certain implementations consistent with the present invention.

### DETAILED DESCRIPTION

While this invention is susceptible of embodiment in many different forms, there is shown in the drawings and will herein be described in detail specific embodiments, with the understanding that the present disclosure of such embodiments is to be considered as an example of the principles and not intended to limit the invention to the specific embodiments shown and described. In the description below, like reference numerals are used to describe the same, similar or corresponding parts in the several views of the drawings.

The terms “a” or “an”, as used herein, are defined as one or more than one. The term “plurality”, as used herein, is defined as two or more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically. The term “program” or “computer program” or similar terms, as used herein, is defined as a sequence of instructions designed for execution on a computer system. A “program”, or “computer program”, may include a subroutine, a function, a procedure, an object method, an object implementation, in an executable application, an applet, a servlet, a source code, an object code, a script, a program module, a shared library/dynamic load library and/or other sequence of instructions designed for execution on a computer system.

The term “program”, as used herein, may also be used in a second context (the above definition being for the first context). In the second context, the term is used in the sense of a “television program”. In this context, the term is used to mean any coherent sequence of audio video content such as those which would be interpreted as and reported in an electronic program guide (EPG) as a single television program, without regard for whether the content is a movie, sporting event, segment of a multi-part series, news broadcast, etc. In this discussion, the use of the term “Program” is generally consistent with that of the MPEG-2 Systems standard (ISO/IEC 13818-1). An MPEG-2 Program has the associated Elementary Stream components, such as for example one video Elementary Stream and one or more audio Elementary Streams. The term may also be interpreted to encompass commercial spots and other program-like content which may not be reported as a program in an electronic program guide.

Reference throughout this document to “one embodiment”, “certain embodiments”, “an embodiment” or similar terms means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner in one or more embodiments without limitation.

The term “or” as used herein is to be interpreted as an inclusive or meaning any one or any combination. Therefore, “A, B or C” means “any of the following: A; B; C; A and B; A and C; B and C; A, B and C”. An exception to this definition will occur only when a combination of elements, functions, steps or acts are in some way inherently mutually exclusive.

Stereoscopic 3D television involves delivery to the display screen of separate views for the left and right eyes, coupled with a method to allow each of the viewer's eyes to see only the image intended for that eye. The illusion of depth is achieved when, for a given object, the left- and right-eye views differ in the horizontal position of that object's placement.

In video displays used for three dimensional stereoscopic (3D) display of content such as movies and the like, there are several techniques used for creation of separation of left eye images from right eye images in order to create the stereoscopic visual effect that simulates a three dimensional image. Since all content is not available or even desirable for display in 3D, commonly used technologies are also employed for display of conventional two dimensional (2D) images.

In one type of LCD display panel used for display of 3D content, a micropolarization layer is utilized. At this writing, this type of display generally utilizes a layer that passes alternating rows of pixels where the alternating rows are polarized with alternating polarization of light. For example, even numbered rows are polarized with left hand circular polarization and odd numbered rows are polarized with right hand circularization (or vice versa). The odd numbered rows can thus be assigned for use in display of left eye images while the even numbered rows can be assigned for use of right eye images. This provides for the stereoscopic image separation by use of appropriately polarized glasses.

In such displays, it is quite desirable to keep the left eye images and right eye images distinctly separated. If not distinctly separated, the cross-talk between left eye and right eye images can cause ghosting, loss of contrast, loss of 3D effect and depth resolution and viewer discomfort, as discussed for example in “Understanding Crosstalk in Stereoscopic Displays”, Woods, A. J. (2010) Keynote presentation at Three Dimensional Systems and Applications Conference,Tokyo, Japan, May, 2010, which is hereby incorporated by reference. This crosstalk can increase as the viewing angle increases and cross-talk as perceived by the viewer can vary depending on the particular content being viewed. Hence, it is also common that there is a spacing provided between rows of pixels and this spacing is further devised to serve as a visual barrier to block light passage and assure minimal crosstalk between left and right eye images.

To further provide for separation of alternating rows of pixels, it is common to make each pixel up of a vertical arrangement of two or more sub-pixels. With a display of this type, commonly the lower sup-pixel is turned off during display of 3D content. This provides for greater separation of left and right eye images.

This manipulation of use of the sub-pixels is done, however, at the expense of energy consumption and brightness since in an LCD display the brightness is determined by both the pixel size (which is reduced by turning off the lower sub-pixel) and by the brightness of the backlighting. So, when 3D content is to be displayed and one or more sub-pixels are turned off for greater vertical viewing angle, the brightness of the backlighting is increased to compensate for the smaller pixel size, thereby dramatically increasing energy consumption during display of 3D content over that which is consumed during display of 2D content (when all sub-pixels are on and backlighting can be reduced. The power difference could be as much as 40% between normal and reduced height pixel modes.

For purposes of this document, it is noted that the present description illustrates two sub-pixels per pixel with a smaller and lower sub-pixel being selectively controlled to be on or off depending on a mode of operation. However, for purposes of various implementations of embodiments consistent with the present invention, the present document refers to and defines two modes of operation of the sub-pixels—a “tall mode” and a “short mode”, where the tall mode is defined as a mode that has more sub-pixels active than a short mode where “tall” and “short” are relative to one another with a tall mode having at least one more active sub-pixel than a short mode. That is, in short mode at least one more sub-pixel is turned off compared with the number of sub-pixels in the tall mode. In general, this means that in order to achieve the same light output from a given pixel in an LCD display, a greater amount of backlight is required in the short mode than in the tall mode. It is noted that in other types of displays than LCD displays, the tall mode and short mode may have opposite characteristics in terms of energy consumption than for an LCD, in which case, the selection of tall of short mode is adjusted accordingly to achieve the desired result of lower energy consumption without substantial compromise of picture quality. It is further noted that although a two sub-pixel display is described herein, the principles are applicable to displays with more than two sub-pixels with the present techniques scaled to encompass modes which can be described as taller or shorter than other modes in varying degrees.

It is noted that it is often the case that a wide viewing angle is not always necessary when displaying and viewing 3D content. In fact, it is common that the actual viewing angle is actually quite narrow. Consider, for example, a family seated on a couch or chairs viewing 3D content. The actual vertical difference between eye level of the viewers is quite a small angle—perhaps no more than a few inches—resulting in a quite narrow viewing angle that would capture the vertical height of all viewers. Hence, if the viewing angle is small, there may be no actual need to turn off the sub-pixels and hence no actual need to turn up the backlighting and cause the additional energy consumption resulting therefrom. The problem with this strategy is that the typical consumer has no idea that adjustment of viewing angle can actually reduce energy consumption. Moreover, there is an opportunity to allow a display system to intervene when it detects that a wide vertical viewing angle is unnecessary.

Depending upon the viewing environment, the 3D display may or may not require a wide vertical viewing angle. If the display were to know the location of the viewers, the tradeoff between power consumption and viewing angle could be controlled.

This can be accomplished, for example, by use of a camera, detector or vision system to detect the location of the viewers. Perhaps face detection or perhaps just locating the reflective surface or some indicia provided on the 3D glasses, the location of the viewers can be determined If the viewers are within a narrow viewing angle there would be no need to reduce the pixel vertical height hence the back light would not have to run brighter. The results would be an energy saving. Additionally, the TV can be configured to provide feedback to the user via the user interface (UI) to tilt the display panel in order to save power. This is often readily accomplished since many display panels are wall mounted and many wall brackets offer a tilt adjustment. Thus, manually tilting the display could save power, and the power difference could be as much as 40% between short and tall pixel height modes.

Hence, in certain implementations, the invention provides a system by which a television can reduce its power consumption by tracking the viewer's location. The television can then alter the viewing angle such that it does not need to turn off sub-pixels in the display. This could reduce power consumption in a television by as much as 40%.

While the present discussion uses micropolarized LCD display panels as an example, any display panel that uses sub-pixels to control vertical viewing angle may be susceptible to use of the present technique including LED display panels and lenticular display panels.

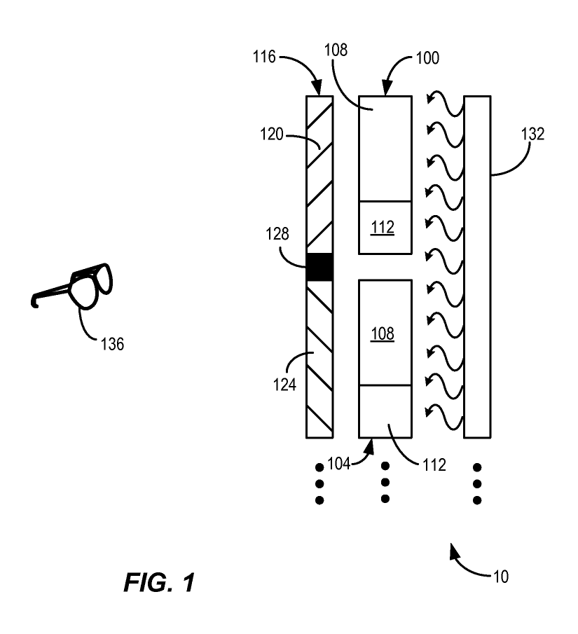

Turning now to FIG. 1, an example micropolarized 3D LCD display panel 10 is depicted in vertical cross-section and in simplified form. In such a display, an array of pixels is made up of horizontal lines of pixels, with each pixel being composed of multiple sub-pixels. In this illustration, two rows of pixels including pixels 100 and 104 are depicted. Pixels 100 and 104 have an upper sub-pixel 108 and a lower sub-pixel 112. Polarization of the display is accomplished by using a micropolarizer 116 which has polarized segments 120 and 124 which are polarized oppositely (e.g., left and right circularly polarized). In one example, each row of pixels is separately polarized and alternating rows are viewed through polarized glasses so that left eye and right eye images are separated.

To achieve good separation when operating in 3D mode, the micropolarizer (or other structure) can provide a light barrier 128 so that the images remain separate. Backlight 132 provides a source of light that passes through the LCD pixels and then out through the micropolarizer 116 to the viewer. It is common, as previously discussed, to turn off a portion of the sub-pixels (e.g., the lower and smaller sub-pixels 112) when using the display panel 10 in 3D mode so as to achieve a wider vertical viewing angle. When this is done, the brightness and therefore the energy consumption of backlight 132 is substantially increased in order to produce adequate brightness to the viewer viewing the display panel through polarizer 116 and polarized glasses 136. In 2D mode, the sub-pixels can all be turned on so that the backlighting can be reduced since separation of adjacent pixels is not as important in conventional 2D viewing and does not significantly negatively impact vertical viewing angle.

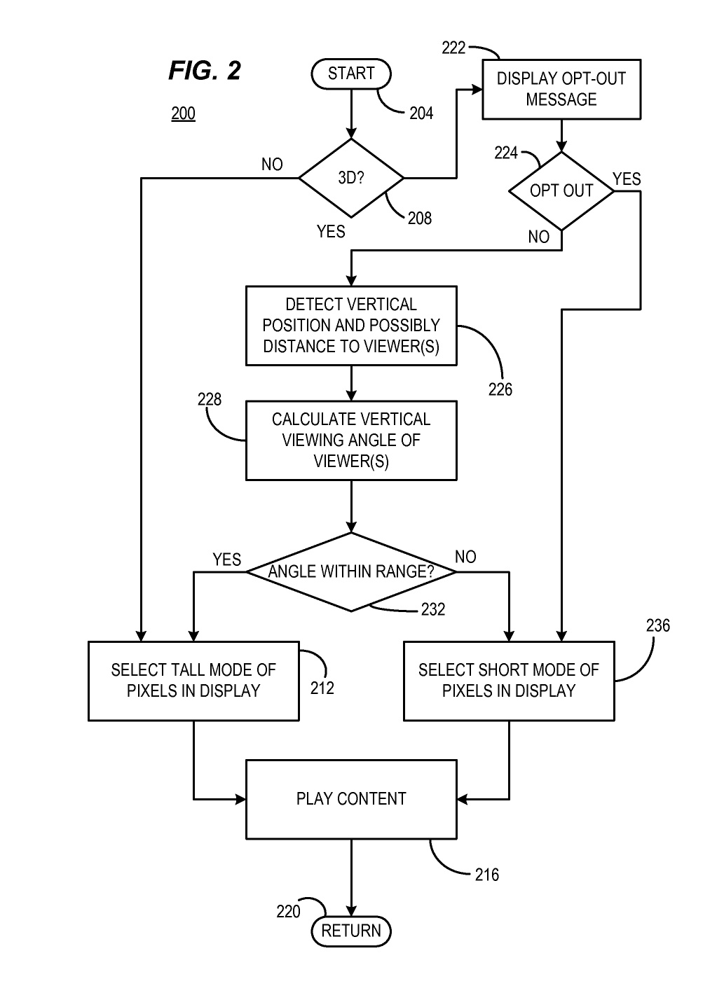

One process for control of a display panel 10 of FIG. 1 is depicted in FIG. 2 as process 200 starting at 204. If the display is operating to display 2D content at 208, the tall mode is implemented at 212 since the separation of adjacent pixels is not as significant, and the content can be displayed normally at 216. The process then returns to the start for future decision making at 220.

If the display is operating in a 3D mode to display stereoscopic content, in accord with this implementation, control passes from 208 to 222 where the system displays an “opt-out” message indicating that the user can opt-out of the process that reduces power consumption in favor of a smaller viewing angle. The user can then elect to proceed with this energy saving process at 224 or opt-out of the process and select higher power consumption in order to improve the video display. If the user elects to proceed with the power saving option, the process proceeds to 226 where the vertical position of a viewer or multiple viewers is detected. A distance to the viewer can also be determined in order to later ascertain a vertical viewing angle of the viewer. This can be done using a camera with face detection, infrared detection, or other techniques that will be discussed. Regardless of the technique, once the position of the viewers is determined, the vertical viewing angle of each viewer or of the tallest and shortest viewers can be calculated at 228. In some implementations, the vertical viewing angle can be ascertained directly without need for actual distance and vertical height information and such implementations are contemplated. This viewing angle range can be compared with a predetermined vertical viewing angle range within which the 3D performance is acceptable without operation with the sub-pixels configured in the short mode. This comparison is done at 232 and if the viewer or viewers are within this range, control passes to 212 and the tall mode is selected for the pixels enabling the backlight intensity to be lower than if the short mode is selected, thereby conserving energy. However, if the viewing angle of each viewer or of the tallest and shortest viewers not within this predetermined range, the short mode of the pixels is selected at 236 and the content plays at 216 using the short mode of the display panel pixels. If the user elects to opt-out of the process at 224, control passes to 236 and the short pixel mode is elected.

The predetermined range discussed above can be readily determined experimentally for any given display panel by viewing a 3D image on the display at varying vertical viewing angles. The predetermined range is established as the range between the upper and lower viewing angle bounded by the point at which image degradation becomes noticeable or subjectively objectionable. It is noted that the range cannot be specified in general since it depends upon the geometries of the pixels, barrier and other parameters specific to the particular display panel and in fact even by the contrast of the content being displayed. But it is noted that in some commercially available display panels, when the short pixel mode is in use, the vertical viewing angle range is approximately 26 degrees from top to bottom. Instead, it is noted that the viewer can best determine when image quality is unsatisfactory on a case by case basis and determine whether to opt-out. The range can be determined by the display manufacturer to provide a generally suitable image quality that a typical viewer would find acceptable. When a narrower viewing angle is unacceptable to the viewer, the viewer can make the judgment to opt-out of using a narrower viewing angle based upon the presence of visible ghosting, loss of contrast, loss of 3D effect and depth resolution, viewer discomfort and overall perception of image quality, etc.

It is noted that TV manufacturers often suggest that a suitable viewing distance is approximately three times the vertical height of a display. Using this criterion, for a 55 inch 16×9 display the vertical height is about 27 inches. Approximate suggested viewing distance is about 81 inches or about 7 feet. This viewing distance can be assumed in some implementations. For a given viewer height, use of the present processes may constrain the height of the display in a particular installation in order to achieve a suitable viewing angle or range of angles.

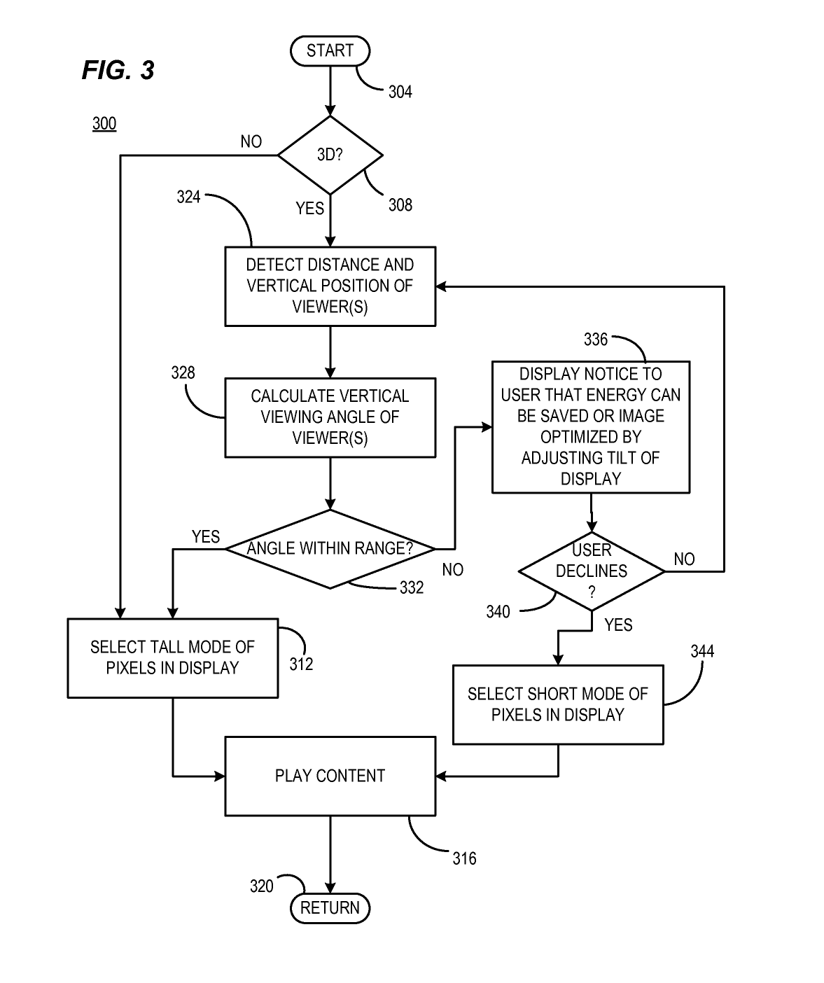

Another process for control of a display panel 10 of FIG. 1 is depicted in FIG. 3 as process 300 starting at 304. In this example, the operation of the display for display of 2D content is omitted but could be added as with process 200 in which case for 2D content control would pass to 312.

If the display is operating in a 3D mode to display stereoscopic content, in accord with this implementation, control passes from 308 to 324 where the vertical position of a viewer or multiple viewers is detected along with distance from the display, or the angular position of the viewer(s) is directly detected. This can be done using a camera with face detection, infrared detection, or other techniques that will be discussed. Regardless of the technique, once the position of the viewers is determined, the vertical viewing angle of each viewer or of the tallest and shortest viewers can be calculated at 328. This viewing angle range can be compared with a predetermined vertical viewing angle range within which the 3D performance is acceptable without operation with the sub-pixels configured in the short mode. This comparison is done at 332 and if the viewer or viewers are within this range, control passes to 312 and the tall mode is selected for the pixels enabling the backlight intensity to be lower than if the short mode is selected, thereby conserving energy. The content can then be displayed normally at 316. The process then returns to the start for future decision making at 320.

However, in this implementation, if the viewing angle of each viewer or of the tallest and shortest viewers not within this predetermined range but would fit within the predetermined range, the display device can alert the user with a message stating that energy can be conserved or the image quality can be improved by adjusting the tilt of the display. It is noted that the range of angles is not an absolute, since image quality is near optimum at some angle and gradually decreases as the viewer's eyes are taken above or below this angle. Accordingly, image quality can also be improved by adjusting the angle to bring the viewer's eyes closer to the optimum viewing angle. In certain implementations, an approximate angular amount of tilt and the direction of the tilt can also be displayed at 336. The user can, in this implementation, then elect to either accept or decline the opportunity to adjust the display tilt at 340 in an attempt to lower energy consumption. If the user declines, the short mode of the pixels is selected at 344 and the content plays at 316 using the short mode of the display panel pixels. However, if the user accepts the opportunity to adjust the display tilt at 340, control returns to 324 so the detection process can be repeated to assure that all users are within the preferred viewing angle. Regardless of whether or not the displayed image is 2D or 3D or whether or not the pixels are in short or tall mode, it is noted that there is always an optimum viewing angle. By detecting that the user is not at that optimum viewing angle, a suggestion for changing the tilt angle can be helpful in optimizing the picture quality without regard for power consumption or display mode.

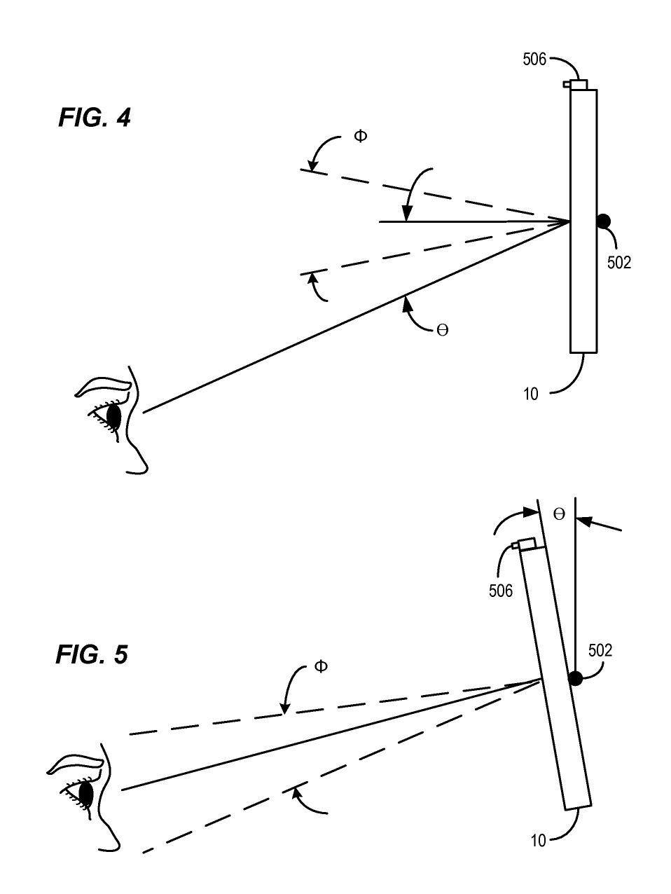

Turning now to FIGS. 4-5, an example of how tilting the display can rectify the viewing angle is depicted. In this case display panel 10 is mounted using a tiltable mount 502 and the display includes a camera 506 to detect the viewer's position by, for example, a programmed processor running a face detection algorithm. In this example, the face detection algorithm can detect the position of the viewer's eyes and this position is designated in the illustration as residing approximately ⊖ degrees below the horizontal. The predetermined range of quality vertical viewing angles is shown as Φ. Hence, it is desirable to tilt the display so that the viewing angle ⊖ is within the range of Φ, and where possible, near the center of the range. When this can be accomplished, as shown in FIG. 5, it involves movement of the display by approximately ⊖ degrees from the vertical so as to optimize the viewer's position.

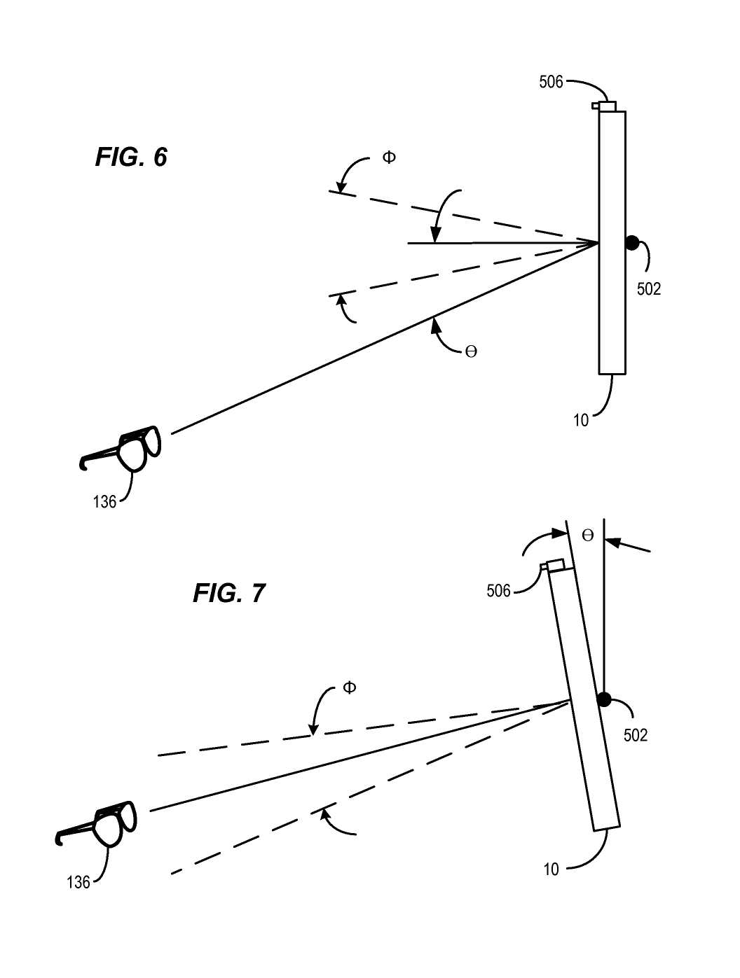

In the implementations described in connection with FIGS. 4-5, a viewer's eye position can be determined by recognizing the face of the viewer, but it is noted that in 3D mode, the viewer will generally be wearing some type of 3D glasses to facilitate separation of left and right eye images. FIGS. 6-7 depict utilization of actual detection of the glasses to determine eye position. In this case, glasses 136 can be detected with pattern recognition by the camera 506 taking advantage of detection of either the glasses form itself, an indicia affixed to the glasses 136, or any variation of a homing mechanism to detect the vertical positioning of the one or more sets of glasses in use. In FIG. 6, the vertical glasses position is representative of the eye position and is again shown by ⊖, which again represents the amount of tilt of the display panel in FIG. 7 to bring the viewer's eyes into the range Φ.

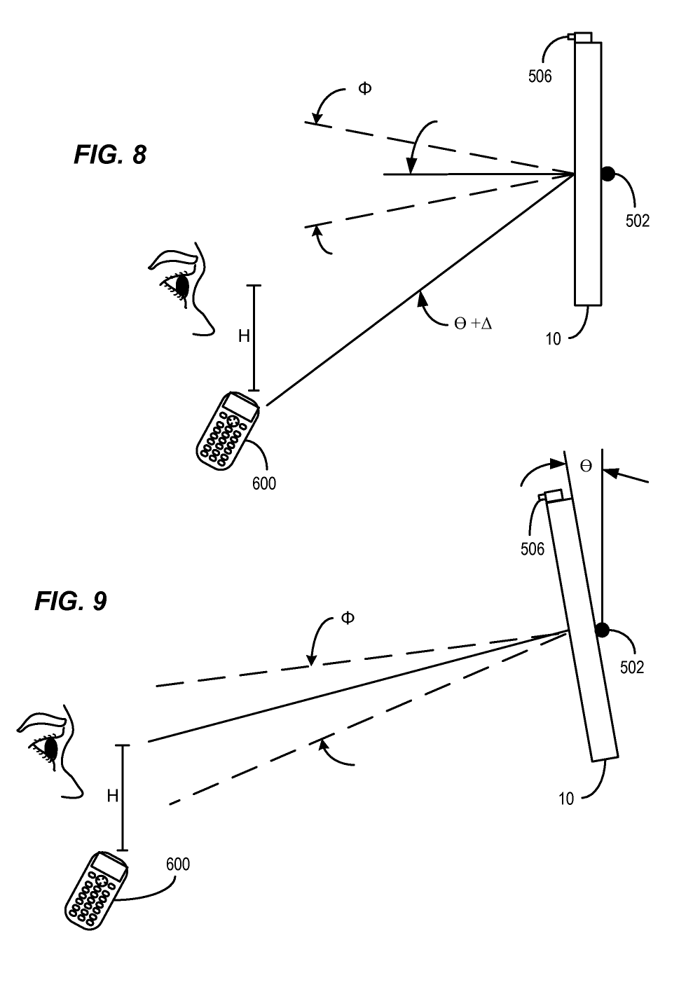

In the above examples, the viewer's eye position is directly deduced by a detector of any configuration that can detect a viewer's face or the position of viewing glasses. Those skilled in the art can devise many alternative implementations which detect the position of the eyes directly. However, one should not overlook the opportunity to deduce the position of the viewer's eyes indirectly. One example technique is depicted in FIGS. 8-9. In this example, the system can utilize the vertical position of a remote controller as a reference point and deduce the position of the viewer's eyes therefrom. For example, if the viewer places the remote controller 600 on a coffee table in front of a couch on which the viewer or viewers sit, it is likely that the viewers eyes will be somewhere between, for example one and two feet above the coffee table. This can be a range that is measured by the viewer as H as shown in FIGS. 8-9 and manually input as a setup parameter. Or, the system can assume this range or other suitable range. In certain implementations the viewer can set the height to accommodate the usual viewers with a normal resting placement of the remote controller on a convenient piece of furniture. This height can be user input or selectable from a menu as a parameter used by the television set. Such parameter can be set up at the time of setting up the television or by suitable menu function. When this height H is assumed, the viewer's eye position can be deduced by detection of the position of the remote controller 600 (e.g., by pattern recognition, indicia, signals sent from the remote that can be triangulated, etc.) and adding a height of H to this position to identify where the eyes are likely located. Of course, in order for this indirect measurement to work properly, either the system has to measure where the remote controller 600 will be positioned horizontal distance from the display, or a distance assumption must be made or the viewer will input a distance or approximate distance horizontally to the display panel. Once this information is known, the angle to the remote controller 600 is given as ⊖+Δ as shown in FIG. 8 and the angle ⊖ can be readily derived and the display adjusted as shown in FIG. 9.

Of course, this indirect method is likely to be less accurate than a direct method, but in a given viewing situation where the viewing positions of the viewers is relatively static, and where the predetermined viewing angle range Φ is wide enough, an approximation may be quite adequate to assure low power consumption and quality viewing. Those skilled in the art will appreciate that other indirect methods may also be utilized in a manner consistent with the present teachings.

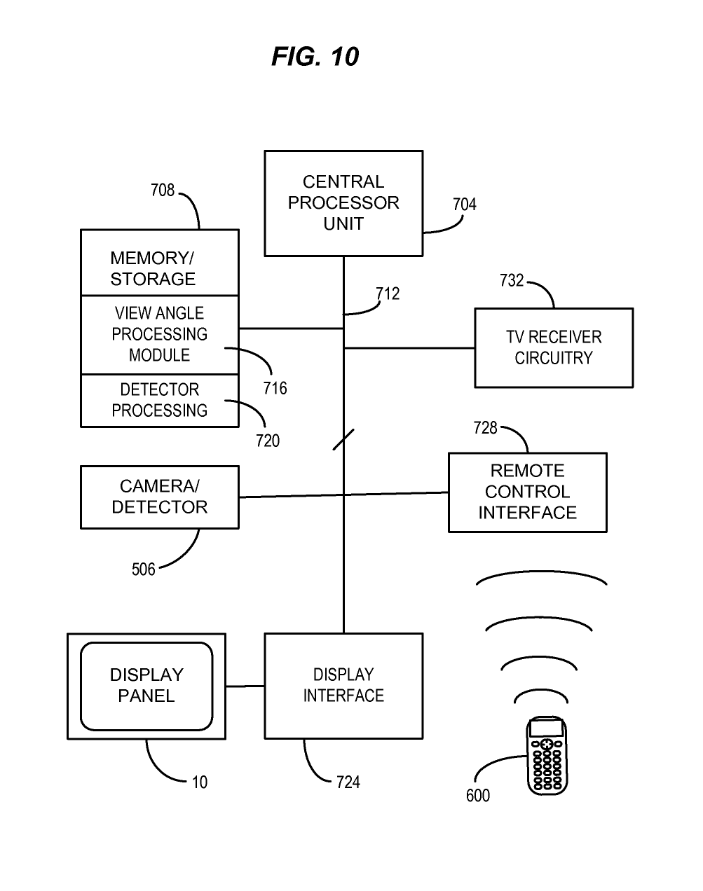

Any of the above techniques can be carried out using a television receiver device that incorporates a camera or other suitable detector 506 as shown in FIG. 10. In such a system, one or more processors 704 are programmed with program modules stored in memory or other storage 708 coupled to the processor(s) using one or more buses 712 in a conventional manner. Memory 708 can incorporate, among other programming and data, a viewing angle processing module 716 that processes and computes viewing angles and ranges thereof as described above and a detector processing module 720 that, for example, carries out facial recognition or pattern matching of images captured by camera or detector 506.

Messages and video content are provided to the display panel 10 via display interface 724 and remote controller commands are received via a remote controller interface 728. The TV receiver device includes various television receiver circuitry 732 which may include various interfaces for receipt of content for display via broadcast, cable, satellite, Internet, media player, etc.

Thus, a method of adjusting pixel height in a display panel having sub-pixelized pixels capable of operating in at least a tall mode and a short mode involves at a detector coupled to the display panel, detecting a position of a viewer viewing the display; at a processor, calculating a vertical viewing angle for a viewer; at the processor, determining if the calculated vertical viewing angle is within a predetermined range of vertical viewing angles; and the processor selecting a tall mode or a short mode for operation of the display panel as a result of the determining

In certain implementations, if the vertical viewing angle is within the predetermined range of vertical viewing angles then operating the display in the tall mode; and if the vertical viewing angle is within the predetermined range of vertical viewing angles then operating the display in the short mode. In certain implementations, the detector is a video camera that is configured to detect a viewer and where the processor determines a vertical position of the viewer relative to the display panel. In certain implementations, the detector detects a plurality of viewers, and where the processor calculates a viewing angle for each of the viewers, and where the determining involves the processor determining if each of the viewing angles is within the predetermined range of vertical viewing angles. In certain implementations, the processor determines if the display is an operational mode for display of 2D content, and if so selects the one of the tall and short modes that consumes less power. In certain implementations, the detector detects a position of an object and where the processor presumes the vertical position of the viewer from the position of the object. In certain implementations, the detector detects a position of a remote controller, and a position of a viewer is presumed or deduced to be a specified height above the position of the remote controller. In certain implementations, the detector detects the position of the viewer by detection of a position of 3D viewing glasses.

Another method of adjusting pixel height in a display panel having sub-pixelized pixels capable of operating in at least a tall mode and a short mode involves at a detector coupled to the display panel, detecting a position of a viewer viewing the display; at a processor, calculating a vertical viewing angle for a viewer; at the processor, determining if the calculated vertical viewing angle is within a predetermined range of vertical viewing angles; and displaying a message on the display panel indicating that power consumption can be reduced by adjustment of a display angle by tilting the display panel in a specified direction.

In certain implementations, the processor selects a tall mode or a short mode for operation of the display panel as a result of the determining. In certain implementations, if the vertical viewing angle is within the predetermined range of vertical viewing angles then operating the display in the tall mode; and if the vertical viewing angle is within the predetermined range of vertical viewing angles then operating the display in the short mode. In certain implementations, the processor determining if the display is an operational mode for display of 2D content, and if so selects the one of the tall and short modes that consumes less power. In certain implementations, the detector is a video camera that is configured to detect a viewer and the processor determines a vertical position of the viewer relative to the display panel. In certain implementations, the detector detects a plurality of viewers, and where the processor calculates a viewing angle for each of the viewers, and where the determining involves the processor determining if each of the viewing angles is within the predetermined range of vertical viewing angles. In certain implementations, the detector detects a position of an object and where the processor presumes the vertical position of the viewer from the position of the object. In certain implementations, the detector detects a position of a remote controller, and where a position of a viewer is presumed to be a specified height above the position of the remote controller. In certain implementations, the detector detects the position of the viewer by detection of a position of 3D viewing glasses.

A television display device consistent with certain implementations has a display panel having sub-pixelized pixels capable of operating in at least a tall mode and a short mode to adjust pixel height. A detector is coupled to the display panel that detects a position of a viewer viewing the display. One or more programmed processors are configured to: calculate a vertical viewing angle for a viewer; determine if the calculated vertical viewing angle is within a predetermined range of vertical viewing angles; and select a tall mode or a short mode for operation of the display panel as a result of the determination if the calculated vertical viewing angle is within the predetermined range of vertical viewing angles.

In certain implementations, if the vertical viewing angle is within the predetermined range of vertical viewing angles then the processor selects to operate the display in the tall mode; and if the vertical viewing angle is within the predetermined range of vertical viewing angles then the processor selects to operate the display in the short mode. In certain implementations, the detector is a video camera that is configured to detect a viewer and where the processor determines a vertical position of the viewer relative to the display panel. In certain implementations, the detector detects a plurality of viewers, and where the processor calculates a viewing angle for each of the viewers, and where the processor determines if each of the viewing angles is within the predetermined range of vertical viewing angles. In certain implementations, the processor further determines if the display is an operational mode for display of 2D content, and if so selects the one of the tall and short modes that consumes less power. In certain implementations, the detector detects a position of an object and where the processor presumes the vertical position of the viewer from the position of the object. In certain implementations, the detector detects a position of a remote controller, and where a position of a viewer is presumed to be a specified height above the position of the remote controller. In certain implementations, the detector detects the position of the viewer by detection of a position of 3D viewing glasses. In certain implementations, the display panel is a micropolarized display panel.

Another television display device has a display panel having sub-pixelized pixels capable of operating in at least a tall mode and a short mode to adjust pixel height. A detector is coupled to the display panel that detects a position of a viewer viewing the display. One or more programmed processors are configured to: alculate a vertical viewing angle for a viewer; determine if the calculated vertical viewing angle is within a predetermined range of vertical viewing angles; and display a message on the display panel indicating that power consumption can be reduced by adjustment of a display angle by tilting the display panel in a specified direction.

In certain implementations, the processor selects a tall mode or a short mode for operation of the display panel as a result of the determining In certain implementations, if the vertical viewing angle is within the predetermined range of vertical viewing angles then the processor selects to operate the display in the tall mode; and if the vertical viewing angle is within the predetermined range of vertical viewing angles then the processor selects to operate the display in the short mode. In certain implementations, the processor determines if the display is an operational mode for display of 2D content, and if so the processor selects the one of the tall and short modes that consumes less power. In certain implementations, the detector is a video camera that is configured to detect a viewer and where the processor determines a vertical position of the viewer relative to the display panel. In certain implementations, the detector detects a plurality of viewers, and where the processor calculates a viewing angle for each of the viewers, and where the determining involves the processor determines if each of the viewing angles is within the predetermined range of vertical viewing angles. In certain implementations, the detector detects a position of an object and where the processor presumes the vertical position of the viewer from the position of the object. In certain implementations, the detector detects a position of a remote controller, and where a position of a viewer is presumed to be a specified height above the position of the remote controller. In certain implementations, the detector detects the position of the viewer by detection of a position of 3D viewing glasses. In certain implementations, the display panel is a micropolarized display panel.

Another method involves at a detector coupled to a display panel, detecting a position of a viewer viewing the display; at a processor, calculating a vertical viewing angle for a viewer; at the processor, comparing the calculated vertical viewing angle to an optimum viewing angle or a predetermined range of vertical viewing angles; and displaying a message on the display panel suggesting that the user tilt the display panel.

In certain implementations, the message suggests adjustment of a display angle by tilting the display panel in a specified direction. In certain implementations, the processor determines if the display is an operational mode for display of 2D content, and if so selecting the one of the tall and short modes that consumes less power. In certain implementations, the detector comprises a video camera that is configured to detect a viewer and where the processor determines a vertical position of the viewer relative to the display panel. In certain implementations, the detector detects a plurality of viewers, and where the processor calculates a viewing angle for each of the viewers. In certain implementations, ere the detector detects a position of an object and where the processor presumes the vertical position of the viewer from the position of the object. In certain implementations, the object comprises a remote controller, and where a position of a viewer is presumed to be a specified height above the position of the remote controller. In certain implementations, the detector detects the position of the viewer by detection of a position of 3D viewing glasses.

A television display device has a display panel and a detector coupled to the display panel that detects a position of a viewer viewing the display. One or more programmed processors are configured to: calculate a vertical viewing angle for a viewer; compare the calculated vertical viewing angle to an optimum viewing angle or a predetermined range of vertical viewing angles; and display a message on the display panel suggesting that the user tilt the display panel.

In certain implementations, the message suggests adjustment of a display angle by tilting the display panel in a specified direction. In certain implementations, the processor determines if the display is an operational mode for display of 2D content, and if so selecting one of a tall and short pixel mode that consumes less power. In certain implementations, the detector comprises a video camera that is configured to detect a viewer and where the processor determines a vertical position of the viewer relative to the display panel. In certain implementations, the detector detects a plurality of viewers, and where the processor calculates a viewing angle for each of the viewers. In certain implementations, the detector detects a position of an object and where the processor presumes the vertical position of the viewer from the position of the object. In certain implementations, the object comprises a remote controller, and where a position of a viewer is presumed to be a specified height above the position of the remote controller. In certain implementations, the detector detects the position of the viewer by detection of a position of 3D viewing glasses.

Another television display device has a micropolarized display panel having sub-pixelized pixels capable of operating in at least a tall mode and a short mode to adjust pixel height. A video camera is coupled to the display panel that detects a position of one or more viewers viewing the display. One or more programmed processors are programmed to: calculate a vertical viewing angle for each of the one or more viewers; determine if the calculated vertical viewing angle for each of the one or more viewers is within a predetermined range of vertical viewing angles; display a message on the display panel indicating that power consumption can be reduced by adjustment of a display angle by tilting the display panel in a specified direction; select a tall mode or a short mode for operation of the display panel as a result of the determining, where if the vertical viewing angle is within the predetermined range of vertical viewing angles then the processor selects to operate the display in the tall mode; and if the vertical viewing angle is within the predetermined range of vertical viewing angles then the processor selects to operate the display in the short mode.

A method of adjusting pixel height in a display panel having sub-pixelized pixels capable of operating in at least a tall mode and a short mode, involves at a processor, generating a display that invites a viewer to choose between a lower power mode and a higher power mode of operation; if the viewer chooses the higher power mode of operation, selecting a short mode for operation of the display panel; if the viewer chooses the lower power mode of operation, at a processor calculating a vertical viewing angle for the viewer, and determining if the calculated vertical viewing angle is within a predetermined range of vertical viewing angles; and the processor selecting a tall mode of operation of the display panel as a result of the determining.

In certain implementations, if the vertical viewing angle is within the predetermined range of vertical viewing angles then operating the display in the tall mode; and if the vertical viewing angle is within the predetermined range of vertical viewing angles then operating the display in the short mode. In certain implementations, the detector is a video camera that is configured to detect a viewer and where the processor determines a vertical position of the viewer relative to the display panel. In certain implementations, the detector detects a plurality of viewers, and where the processor calculates a viewing angle for each of the viewers, and the processor determines if each of the viewing angles is within the predetermined range of vertical viewing angles. In certain implementations, the detector detects a position of an object and where the processor presumes the vertical position of the viewer from the position of the object.

Those skilled in the art will recognize, upon consideration of the above teachings, that certain of the above exemplary embodiments are based upon use of one or more programmed processors programmed with a suitable computer program. However, the invention is not limited to such exemplary embodiments, since other embodiments could be implemented using hardware component equivalents such as special purpose hardware and/or dedicated processors. Similarly, general purpose computers, microprocessor based computers, micro-controllers, optical computers, analog computers, dedicated processors, application specific circuits and/or dedicated hard wired logic may be used to construct alternative equivalent embodiments.

Certain embodiments described herein, are or may be implemented using a programmed processor executing programming instructions that are broadly described above in flow chart form that can be stored on any suitable electronic or computer readable storage medium. However, those skilled in the art will appreciate, upon consideration of the present teaching, that the processes described above can be implemented in any number of variations and in many suitable programming languages without departing from embodiments of the present invention. For example, the order of certain operations carried out can often be varied, additional operations can be added or operations can be deleted without departing from certain embodiments of the invention. Error trapping, time outs, etc. can be added and/or enhanced and variations can be made in user interface and information presentation without departing from certain embodiments of the present invention. Such variations are contemplated and considered equivalent.

While certain illustrative embodiments have been described, it is evident that many alternatives, modifications, permutations and variations will become apparent to those skilled in the art in light of the foregoing description.

What is claimed is:

1. A method of adjusting pixel height in a display panel having sub-pixelized pixels capable of operating in at least a tall mode and a short mode, comprising:
at a detector coupled to the display panel, detecting a position of a viewer viewing the display;
at a processor, calculating a vertical viewing angle for a viewer;
at the processor, determining if the calculated vertical viewing angle is within a predetermined range of vertical viewing angles; and
the processor selecting a tall mode or a short mode for operation of the display panel as a result of the determining.

2. The method according to claim 1, where if the vertical viewing angle is within the predetermined range of vertical viewing angles then operating the display in the tall mode; and if the vertical viewing angle is within the predetermined range of vertical viewing angles then operating the display in the short mode.

3. The method according to claim 1, where the detector comprises a video camera that is configured to detect a viewer and where the processor determines a vertical position of the viewer relative to the display panel.

4. The method according to claim 1, where the detector detects a plurality of viewers, and where the processor calculates a viewing angle for each of the viewers, and where the determining comprises the processor determines if each of the viewing angles is within the predetermined range of vertical viewing angles.

5. The method according to claim 1, further comprising the processor determining if the display is an operational mode for display of 2D content, and if so selecting the one of the tall and short modes that consumes less power.

6. The method according to claim 1, where the detector detects a position of an object and where the processor presumes the vertical position of the viewer from the position of the object.

7. The method according to claim 6, where the detector detects a position of a remote controller, and where a position of a viewer is presumed to be a specified height above the position of the remote controller.

8. The method according to claim 1, where the detector detects the position of the viewer by detection of a position of 3D viewing glasses.

9. A method of adjusting pixel height in a display panel having sub-pixelized pixels capable of operating in at least a tall mode and a short mode, comprising:
at a detector coupled to the display panel, detecting a position of a viewer viewing the display;
at a processor, calculating a vertical viewing angle for a viewer;
at the processor, determining if the calculated vertical viewing angle is within a predetermined range of vertical viewing angles; and
displaying a message on the display panel indicating that power consumption can be reduced by adjustment of a display angle by tilting the display panel in a specified direction.

10. The method according to claim 9, further comprising the processor selecting a tall mode or a short mode for operation of the display panel as a result of the determining.

11. The method according to claim 10, where if the vertical viewing angle is within the predetermined range of vertical viewing angles then operating the display in the tall mode; and if the vertical viewing angle is within the predetermined range of vertical viewing angles then operating the display in the short mode.

12. The method according to claim 10, further comprising the processor determining if the display is an operational mode for display of 2D content, and if so selecting the one of the tall and short modes that consumes less power.

13. The method according to claim 9, where the detector comprises a video camera that is configured to detect a viewer and where the processor determines a vertical position of the viewer relative to the display panel.

14. The method according to claim 9, where the detector detects a plurality of viewers, and where the processor calculates a viewing angle for each of the viewers, and where the determining comprises the processor determines if each of the viewing angles is within the predetermined range of vertical viewing angles.

15. The method according to claim 9, where the detector detects a position of an object and where the processor presumes the vertical position of the viewer from the position of the object.

16. The method according to claim 9, where the detector detects a position of a remote controller, and where a position of a viewer is presumed to be a specified height above the position of the remote controller.

17. The method according to claim 9, where the detector detects the position of the viewer by detection of a position of 3D viewing glasses.

18. A television display device, comprising:
a display panel having sub-pixelized pixels capable of operating in at least a tall mode and a short mode to adjust pixel height;
a detector coupled to the display panel that detects a position of a viewer viewing the display;
one or more programmed processors configured to:
calculate a vertical viewing angle for a viewer;
determine if the calculated vertical viewing angle is within a predetermined range of vertical viewing angles; and
select a tall mode or a short mode for operation of the display panel as a result of the determination if the calculated vertical viewing angle is within the predetermined range of vertical viewing angles.

19. The television display device according to claim 18, where if the vertical viewing angle is within the predetermined range of vertical viewing angles then the processor selects to operate the display in the tall mode; and if the vertical viewing angle is within the predetermined range of vertical viewing angles then the processor selects to operate the display in the short mode.

20. The television display device according to claim 18, where the detector comprises a video camera that is configured to detect a viewer and where the processor determines a vertical position of the viewer relative to the display panel.

21. The television display device according to claim 18, where the detector detects a plurality of viewers, and where the processor calculates a viewing angle for each of the viewers, and where the determining comprises the processor determines if each of the viewing angles is within the predetermined range of vertical viewing angles.

22. The television display device according to claim 18, where the processor further determines if the display is an operational mode for display of 2D content, and if so selects the one of the tall and short modes that consumes less power.

23. The television display device according to claim 18, where the detector detects a position of an object and where the processor presumes the vertical position of the viewer from the position of the object.

24. The television display device according to claim 23, where the detector detects a position of a remote controller, and where a position of a viewer is presumed to be a specified height above the position of the remote controller.

25. The television display device according to claim 18, where the detector detects the position of the viewer by detection of a position of 3D viewing glasses.

26. The television display device according to claim 18, where the display panel comprises a micropolarized display panel.

27. A television display device, comprising:
a display panel having sub-pixelized pixels capable of operating in at least a tall mode and a short mode to adjust pixel height;
a detector coupled to the display panel that detects a position of a viewer viewing the display;
one or more programmed processors configured to:
calculate a vertical viewing angle for a viewer;
determine if the calculated vertical viewing angle is within a predetermined range of vertical viewing angles; and
display a message on the display panel indicating that power consumption can be reduced by adjustment of a display angle by tilting the display panel in a specified direction.

28. The television display device according to claim 27, where the processor selects a tall mode or a short mode for operation of the display panel as a result of the determining.

29. The television display device according to claim 28, where if the vertical viewing angle is within the predetermined range of vertical viewing angles then the processor selects to operate the display in the tall mode; and if the vertical viewing angle is within the predetermined range of vertical viewing angles then the processor selects to operate the display in the short mode.

30. The television display device according to claim 28, further comprising the processor determining if the display is an operational mode for display of 2D content, and if so the processor selects the one of the tall and short modes that consumes less power.

31. The television display device according to claim 27, where the detector comprises a video camera that is configured to detect a viewer and where the processor determines a vertical position of the viewer relative to the display panel.

32. The television display device according to claim 27, where the detector detects a plurality of viewers, and where the processor calculates a viewing angle for each of the viewers, and where the determining comprises the processor determines if each of the viewing angles is within the predetermined range of vertical viewing angles.

33. The television display device according to claim 27, where the detector detects a position of an object and where the processor presumes the vertical position of the viewer from the position of the object.

34. The television display device according to claim 27, where the detector detects a position of a remote controller, and where a position of a viewer is presumed to be a specified height above the position of the remote controller.

35. The television display device according to claim 27, where the detector detects the position of the viewer by detection of a position of 3D viewing glasses.

36. The television display device according to claim 27, where the display panel comprises a micropolarized display panel.

37. A method, comprising:
at a detector coupled to a display panel, detecting a position of a viewer viewing the display;
at a processor, calculating a vertical viewing angle for a viewer;
at the processor, comparing the calculated vertical viewing angle to an optimum viewing angle or a predetermined range of vertical viewing angles; and
displaying a message on the display panel suggesting that the user tilt the display panel.

38. The method according to claim 37, where the message suggests adjustment of a display angle by tilting the display panel in a specified direction.

39. The method according to claim 37, further comprising the processor determining if the display is an operational mode for display of 2D content, and if so selecting one of a tall and a short pixel modes that consumes less power.

40. The method according to claim 37, where the detector comprises a video camera that is configured to detect a viewer and where the processor determines a vertical position of the viewer relative to the display panel.

41. The method according to claim 37, where the detector detects a plurality of viewers, and where the processor calculates a viewing angle for each of the viewers.

42. The method according to claim 37, where the detector detects a position of an object and where the processor presumes the vertical position of the viewer from the position of the object.

43. The method according to claim 42, where the object comprises a remote controller, and where a position of a viewer is presumed to be a specified height above the position of the remote controller.

44. The method according to claim 42, where the detector detects the position of the viewer by detection of a position of 3D viewing glasses.

45. A television display device, comprising:
a display panel;
a detector coupled to the display panel that detects a position of a viewer viewing the display;
one or more programmed processors configured to:
calculate a vertical viewing angle for a viewer;
compare the calculated vertical viewing angle to an optimum viewing angle or a predetermined range of vertical viewing angles; and
display a message on the display panel suggesting that the user tilt the display panel.

46. The device according to claim 45, where the message suggests adjustment of a display angle by tilting the display panel in a specified direction.

47. The method according to claim 45, further comprising the processor determining if the display is an operational mode for display of 2D content, and if so selecting the one of the tall and short modes that consumes less power.

48. The method according to claim 45, where the detector comprises a video camera that is configured to detect a viewer and where the processor determines a vertical position of the viewer relative to the display panel.

49. The method according to claim 45, where the detector detects a plurality of viewers, and where the processor calculates a viewing angle for each of the viewers.

50. The method according to claim 45, where the detector detects a position of an object and where the processor presumes the vertical position of the viewer from the position of the object.

51. The method according to claim 50, where the object comprises a remote controller, and where a position of a viewer is presumed to be a specified height above the position of the remote controller.

52. The method according to claim 50, where the detector detects the position of the viewer by detection of a position of 3D viewing glasses.

53. A television display device, comprising:
a micropolarized display panel having sub-pixelized pixels capable of operating in at least a tall mode and a short mode to adjust pixel height;
a video camera coupled to the display panel that detects a position of one or more viewers viewing the display;
one or more programmed processors configured to:
calculate a vertical viewing angle for each of the one or more viewers;
determine if the calculated vertical viewing angle for each of the one or more viewers is within a predetermined range of vertical viewing angles;
display a message on the display panel indicating that power consumption can be reduced by adjustment of a display angle by tilting the display panel in a specified direction;
selects a tall mode or a short mode for operation of the display panel as a result of the determining, where if the vertical viewing angle is within the predetermined range of vertical viewing angles then the processor selects to operate the display in the tall mode; and
if the vertical viewing angle is within the predetermined range of vertical viewing angles then the processor selects to operate the display in the short mode.

54. A method of adjusting pixel height in a display panel having sub-pixelized pixels capable of operating in at least a tall mode and a short mode, comprising:
at a processor, generating a display that invites a viewer to choose between a lower power mode and a higher power mode of operation;
if the viewer chooses the higher power mode of operation, selecting a short mode for operation of the display panel;
if the viewer chooses the lower power mode of operation, at a processor calculating a vertical viewing angle for the viewer, and determining if the calculated vertical viewing angle is within a predetermined range of vertical viewing angles; and
the processor selecting a tall mode of operation of the display panel as a result of the determining.

55. The method according to claim 54, where if the vertical viewing angle is within the predetermined range of vertical viewing angles then operating the display in the tall mode; and if the vertical viewing angle is within the predetermined range of vertical viewing angles then operating the display in the short mode.

56. The method according to claim 54, where the detector comprises a video camera that is configured to detect a viewer and where the processor determines a vertical position of the viewer relative to the display panel.

57. The method according to claim 54, where the detector detects a plurality of viewers, and where the processor calculates a viewing angle for each of the viewers, and where the determining comprises the processor determines if each of the viewing angles is within the predetermined range of vertical viewing angles.

58. The method according to claim 54, where the detector detects a position of an object and where the processor presumes the vertical position of the viewer from the position of the object.
